(19) United States
(12) Patent Application Publication
(10) Pub. No.: US 2008/0107951 A1
(43) Pub. Date: May 8, 2008

(54) FUEL CELL DEVICE AND THE MANUFACTURING METHOD THEREOF

(76) Inventors: FENG-YI DENG, TAIPEI (TW); KUEN-SHEN SHEN, TAINAN (TW); TZ-LUNG YU, TAOYUAN (TW)

Correspondence Address: G. LINK CO., LTD., 3550 BELL ROAD, MINOOKA, IL, 60447, US

(21) Appl. No.: 11/934,086

(22) Filed: Nov. 2, 2007

(30) Foreign Application Priority Data
Nov. 3, 2006 (TW) 095140677

(51) Int. Cl. H01M 8/10; H01M 8/04

(52) U.S. Cl. 429/33; 29/623.1; 429/30

(57) ABSTRACT

The present invention provides a fuel cell device, which at least comprises: at least one membrane electrode assembly, at least one fuel flow board, and at least one permeability membrane; wherein, the membrane electrode assembly is provided with an anode electrode, a cathode electrode, and an electrolyte membrane; and, the permeability membrane is configured between the membrane electrode assembly and the fuel flow board, so that the liquid fuel flowing into the fuel flow board could permeate into the permeability membrane, and reducing the density of liquid fuel permeating from the permeability membrane; and, the liquid fuel permeating from the permeability membrane is the liquid fuel with lower density, and is supplied to the anode electrode of the membrane electrode assembly for electrochemical reaction.

### FIELD OF THE INVENTION

The present invention relates to a fuel cell device, and particularly to a fuel cell device for solving the methanol crossover problem and providing high performance.

### BACKGROUND OF THE INVENTION

The fuel cell is a power generation device by directly converting the chemical energy stored in the fuel and oxidant into electricity through electrode reaction. There are numerous types of fuel cell, and with different categorization methods. If the fuel cells are categorized by the difference of electrolyte characteristics, there are five types of fuel cells with different electrolytes, such as alkaline fuel cell, phosphorous acid fuel cell, proton exchange membrane fuel cell, molten carbonate fuel cell, solid oxide fuel cell; wherein, the proton exchange membrane fuel cell further includes so-called direct methanol fuel cell, which directly employs methanol as the fuel without transforming into hydrogen first, and becomes one of the technologies with more development resources, and the application targets include the large-scale power generation plant, generator for mobile, and portable power supply, etc.

Making an example of direct methanol fuel cell, when employing the methanol aqueous solution as the fuel supplied to the anode electrode of the membrane electrode assembly, the un-reacted methanol will pass through the electrolyte membrane in the membrane electrode assembly, and further diffuse onto the cathode electrode. Thus, it will induce the methanol crossover effect, and result in the substantial reduction of fuel cell performance. To this end, the associated research has proposed to employ the low-density methanol aqueous solution, such as 6˜16 wt %, so as to reduce the chance of methanol crossover and improve the output performance of fuel cell. However, because the conventional fuel cell has very complicated fuel density dilution process, the volume of fuel cell could not be effectively controlled.

### SUMMARY OF THE INVENTION

The main object of the present invention is to provide a fuel cell device, which could solve the problem of insufficient output performance caused by methanol crossover effect.

The other object of the present invention is to provide a fuel cell device, which could directly employ the high density fuel, and eliminate the complicated fuel density dilution process required by the conventional fuel cell, so as to effectively reduce the overall volume of the fuel cell.

To this end, the present invention provides a fuel cell device, which at least comprises: at least one fuel flow board, and at least one membrane electrode assembly; wherein, the membrane electrode assembly is provided with an anode electrode, a cathode electrode, and an electrolyte membrane; and, at least one permeability membrane, which is configured between the membrane electrode assembly and the fuel flow board, so that the liquid fuel flowing into the fuel flow board could permeate into the permeability membrane, and reducing the density of liquid fuel permeating from the permeability membrane; and, the liquid fuel permeating from the permeability membrane is supplied to the anode electrode of the membrane electrode assembly for electrochemical reaction.

Moreover, the present invention also provides a manufacturing method for fuel cell device, which includes the following steps: providing at least one membrane electrode assembly, in which the membrane electrode assembly is provided with an anode electrode, a cathode electrode, and an electrolyte membrane; at least one fuel flow board; and, at least one permeability membrane, which is configured between the membrane electrode assembly and the fuel flow board.

### BRIEF DESCRIPTION OF THE DRAWINGS

The present invention would be detailed described in the following to make the skilled in the art understand the object, features and effects of the present invention through the following embodiments and the attached figures, wherein:

FIG. 1A is a three-dimensional explode diagram of the basic portion in a preferred embodiment of the fuel cell device according to the present invention;

FIG. 1B is a cross-sectional diagram of the fuel cell device in FIG. 1A after assembly;

FIG. 2 is a performance test diagram of the permeability membrane in FIG. 1A applied in the methanol aqueous solution in density value of 30%;

FIG. 3 is a flowchart of the manufacturing method for the fuel cell device according to the present invention;

FIG. 4A is a curve diagram of the voltage versus the current variation for the fuel cell device according to the present invention and the fuel cell device without the permeability membrane, respectively; and

FIG. 4B is a curve diagram of the power versus the current variation for the fuel cell device according to the present invention and the fuel cell device without the permeability membrane, respectively.

### DETAILED DESCRIPTION THE INVENTION

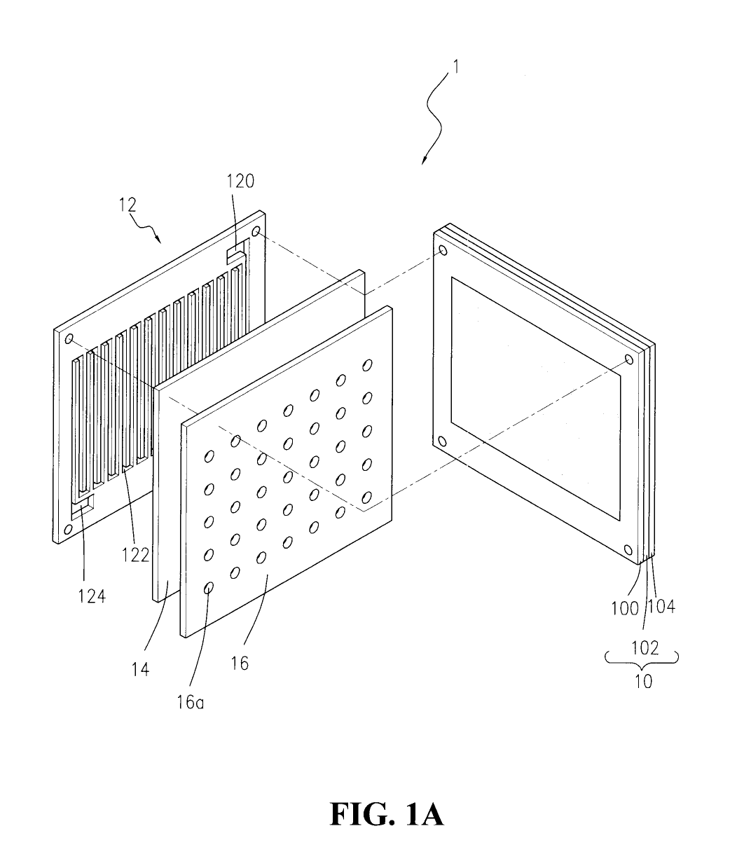

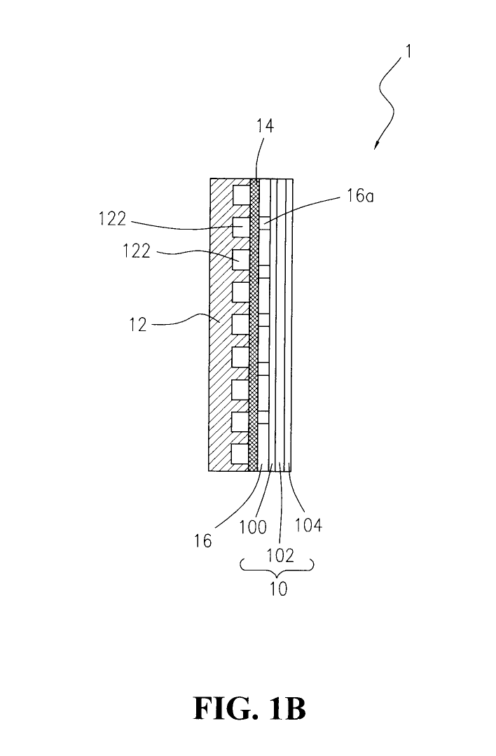

As shown in FIG. 1A, the fuel cell device 1 according to the present invention at least comprises a membrane electrode assembly 10, a fuel flow board 12, a current collector 16, and a permeability membrane 14. As for the other portions constituting a complete fuel cell, such as fuel channel structure, fuel storage tank, cathode fuel flow board, and fuel mixing tank, because they are not the key points of the present invention, they will not be described herein for clarity.

As shown in FIGS. 1A and 1B, the membrane electrode assembly 10 is provided with an anode electrode 100, a cathode electrode 104, and an electrolyte membrane 102; wherein, the anode electrode 100 and the cathode electrode 104 are configured in opposite; and, the electrolyte membrane 102 is located between the anode electrode 100 and the cathode electrode 104, and the electrolyte membrane 102 could employ the electrolyte membrane with excellent ion conductivity, such as proton exchange membrane.

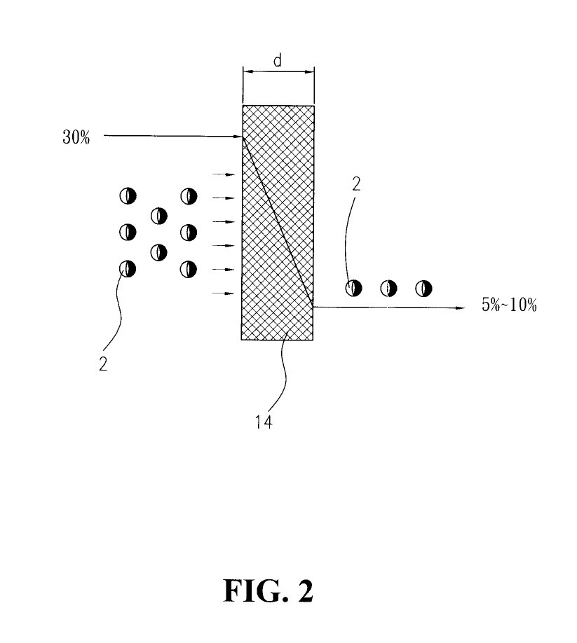

The fuel flow board 12 is particularly related to an anode fuel flow board in the present invention, and the fuel flow board 12 is provided with a fuel inlet 120, a channel structure 122 and a fuel outlet 124. Because the fuel cell device 1 according to the present invention could be suitable for the direct methanol fuel cell (DMFC), the liquid fuel flowing into the fuel flow board 12 is the methanol aqueous solution. One of the improved effects in the present invention is that the liquid fuel flowing into the fuel flow board 12 could be directly employed without the density dilution process. The technical principle for realizing the above-mentioned effects according to the present invention is related to the permeability membrane 14, which will be further described in details in FIG. 2. Referring to FIG. 1A, the liquid fuel could flow into the fuel flow board 12 from the fuel inlet 120, and then pass through the channel structure 122, and finally flow out of the fuel flow board 12 from the fuel outlet 124.

The permeability membrane 14 is configured between the membrane electrode assembly 10 and the fuel flow board 12. Please refer to FIGS. 1A and 1B. The permeability membrane 14 is sandwiched and fixed in the fuel flow board 12 and the current collector 16. With the above-mentioned configuration, the liquid fuel flowing into the fuel flow board 12 could permeate into the permeability membrane 14, and reducing the density of liquid fuel permeating from the permeability membrane 14; and, the liquid fuel permeating from the permeability membrane 14 passes through the through holes 16a of the current collector 16, and is supplied to the anode electrode 100 for electrochemical reaction.

Referring to FIG. 2, the permeability membrane 14 is provided with the effect of diluting the liquid fuel density. After the methanol aqueous solution in density of 30 wt % is permeated into the permeability membrane 14, because the structure of the permeability membrane 14 is provided with the characteristic for blocking the methanol molecule 2, the density of the methanol aqueous solution will be gradually reduced following the increase of the thickness d of the permeability membrane 14, and finally becoming the methanol aqueous solution in density of 5˜10 wt %. It could be understood that the permeability membrane 14 is provided with the effect of density dilution, so it could be applied in the fuel density dilution process required by the conventional fuel cell. The permeability membrane 14 used in the present invention could be embodied with perfluorosulfonic acid film, and the suitable thickness of the perfluorosulfonic acid film is 200 μm.

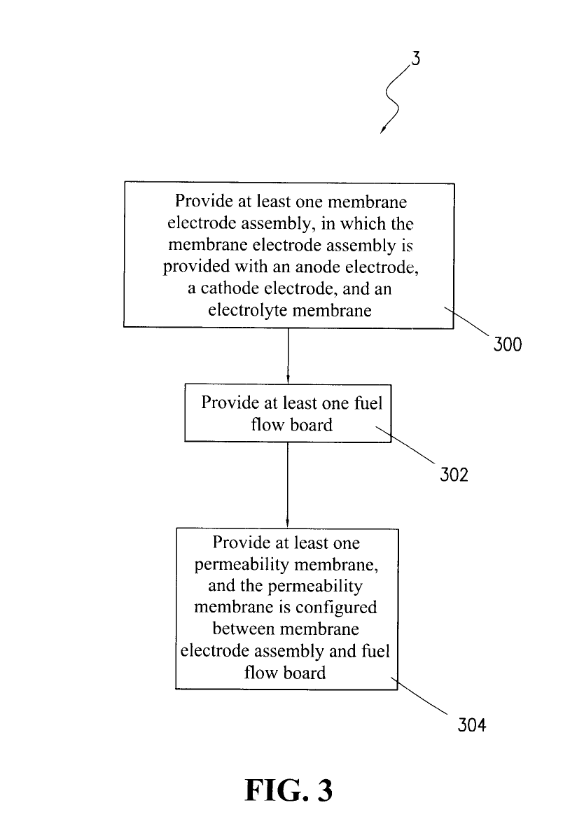

FIG. 3 is a flowchart of the manufacturing method for the fuel cell device according to the present invention. The manufacturing method 3 shown in FIG. 3 mainly includes Step 300, Step 302, and Step 304. Please also refer to FIG. 1A for the explanation of each step. Step 300 is provided with at least one membrane electrode assembly 10, in which the membrane electrode assembly 10 is provided with an anode electrode 100, a cathode electrode 102, and an electrolyte membrane 104, and the electrolyte membrane 104 could employ the proton exchange membrane. Moreover, Step 302 is provided with at least one fuel flow board 12. Then, Step 304 is provided with at least one permeability membrane 14, and the permeability membrane 14 is configured between the membrane electrode assembly 10 and the fuel flow board 12. The provided permeability membrane 14 could employ, for example, the perfluorosulfonic acid film in the thickness of 200 μm. Finally, the fuel cell device manufactured with the manufacturing method 3 according to the present invention would be the same as the fuel cell device 1 as shown in FIGS. 1A and 1B.

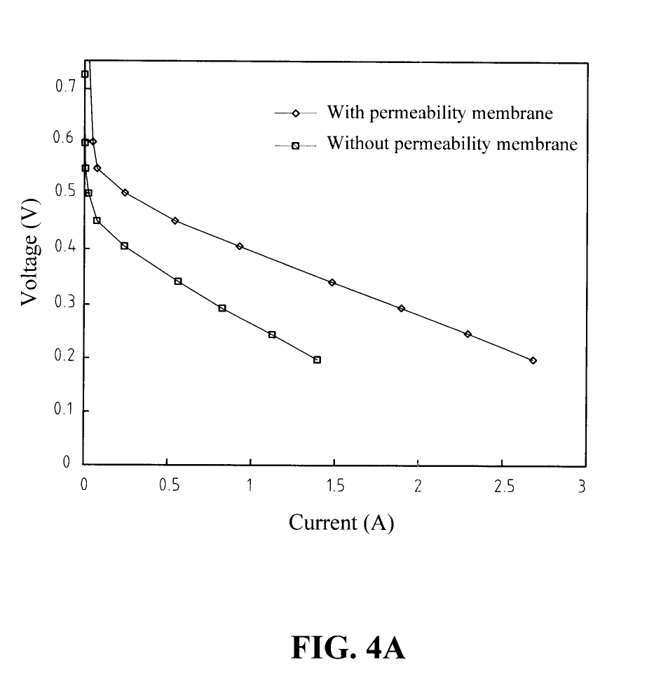

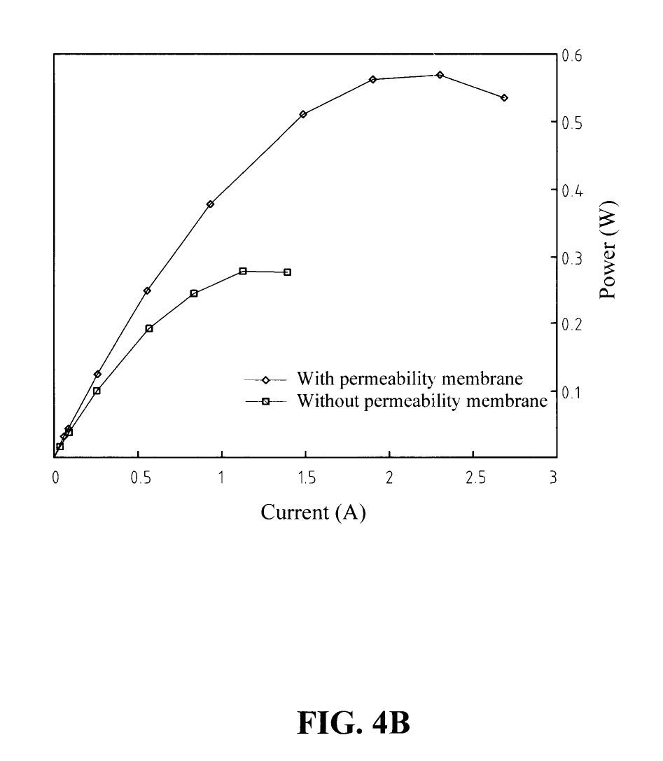

FIG. 4A is a curve diagram of the voltage versus the current variation for the fuel cell device according to the present invention and the fuel cell device without the permeability membrane, respectively. Under the same current of 1 A, the fuel cell device 1 according to the present invention will have the voltage of 0.4V due to the effect of adding with permeability membrane 14. However, the voltage of the fuel cell device without the permeability membrane will be about 0.26V. Comparatively, the voltage of the fuel cell device 1 according to the present invention is obviously higher than the voltage of the fuel cell device without the permeability membrane.

Furthermore, FIG. 4B is a curve diagram of the power versus the current variation for the fuel cell device 1 according to the present invention and the fuel cell device without the permeability membrane, respectively. Under the same current of 1 A, the fuel cell device 1 according to the present invention will generate the power slightly largely than 0.4 W due to the effect of adding with permeability membrane 14. However, the power generated by the fuel cell device without the permeability membrane will be less than 0.3 W. Comparatively, the power for the fuel cell device 1 according to the present invention is obviously higher than the power for the fuel cell device without the permeability membrane.

As shown in FIGS. 4A and 4B, no matter for the output voltage or the output power, the fuel cell device 1 according to the present invention is obviously higher than the fuel cell device without permeability membrane. Thus, the fuel cell device 1 according to the present invention could effectively solve the problem of insufficient output performance caused by methanol crossover effect, which is frequently occurred in the conventional fuel cell. The point is the major advantage of the present invention. Moreover, the fuel cell device 1 according to the present invention employs the permeability membrane 14 providing the function of diluting fuel density, it could directly employ the high density fuel, and eliminate the complicated fuel density dilution process required by the conventional fuel cell, which could effectively reduce the overall volume of the fuel cell.

The present invention has been disclosed with embodiments as above. However, the disclosed embodiments are not used to limit the present invention. The skilled in the art could make various changes and modification without departing from the spirit and scope of the present invention, and the changes and modification made thereto are all belonging to the scope of the present invention. The protection scope for the present invention should be defined with the attached claims.

What is claimed is:

1. A fuel cell device, which at least comprises:
at least one membrane electrode assembly, in which the membrane electrode assembly is provided with an anode electrode, a cathode electrode, and an electrolyte membrane;
at least one fuel flow board;
at least one permeability membrane, which is configured between the membrane electrode assembly and the fuel flow board, and used to make liquid fuel flowing into the fuel flow board permeating into the permeability membrane, and reduce the density of the liquid fuel permeating from the permeability membrane, and then the liquid fuel permeating from the permeability membrane is supplied to the anode electrode for electrochemical reaction.

2. The fuel cell device according to claim 1, wherein the permeability membrane is a perfluorosulfonic acid film.

3. The fuel cell device according to claim 2, wherein the thickness of perfluorosulfonic acid film is 200 μm.

4. The fuel cell device according to claim 1, wherein the fuel cell is the methanol aqueous solution.

5. The fuel cell device according to claim 1, wherein the fuel cell device is a direct methanol fuel cell.

6. The fuel cell device according to claim 1, wherein the electrolyte membrane is a proton exchange membrane.

7. A manufacturing method for fuel cell device, which includes the following steps:
providing at least one membrane electrode assembly, in which the membrane electrode assembly is provided with an anode electrode, a cathode electrode, and an electrolyte membrane;
providing at least one fuel flow board; and,
providing at least one permeability membrane, and the permeability membrane is configured between the membrane electrode assembly and the fuel flow board.

8. The manufacturing method for fuel cell device according to claim 7, wherein the permeability membrane is a perfluorosulfonic acid film.

9. The manufacturing method for fuel cell device according to claim 8, wherein the thickness of perfluorosulfonic acid film is 200 μm.

10. The manufacturing method for fuel cell device according to claim 7, wherein the electrolyte film is a proton exchange membrane.
